(19) United States
(12) Patent Application Publication
(10) Pub. No.: US 2026/0293966 A1
(43) Pub. Date: Oct. 1, 2026

(54) METHOD AND APPARATUS FOR ALIGNING ELONGATE SUSCEPTOR ELEMENTS IN AN AEROSOL-FORMING SUBSTRATE

(71) Applicant: Philip Morris Products S.A., Neuchatel (CH)

(72) Inventors: Oleg MIRONOV, Cudrefin (CH); Andreas Michael ROSSOLL, Le Mont-sur-Lausanne (CH); Alessio DI GIUSEPPE, Modena (IT); Lorenzo BENASSI, Bologna (IT); Julien VIDAL, Peseux (CH)

(73) Assignee: Philip Morris Products S.A., Neuchatel (CH)

(21) Appl. No.: 19/477,300

(22) PCT Filed: Apr. 25, 2024
(86) PCT No.: PCT/EP2024/061432

§ 371 Date: Oct. 21, 2025

(30) Foreign Application Priority Data
Apr. 25, 2023 (EP) 23169697.2

(51) Int. Cl. A24C 5/01; A24B 15/16; A24C 5/18; A24F 40/20; A24F 40/465; A24F 40/70

(52) U.S. Cl. CPC A24C 5/01; A24B 15/16; A24C 5/1892; A24F 40/20; A24F 40/465; A24F 40/70

(57) ABSTRACT

A method of aligning elongate susceptor elements in or on an aerosol-forming substrate for an inductively heatable aerosol-generating article is provided, the method including the steps of: providing an aerosol-forming substrate in the form of a sheet material, the aerosol-forming substrate including a plurality of elongate susceptor elements; arranging the sheet material close to a magnetic alignment device; and applying an aligning magnetic field to the aerosol-forming substrate by the magnetic alignment device, the aligning magnetic field causing the elongate susceptor elements to be attracted and aligned along the aligning magnetic field at least partially with respect to a reference axis of the sheet material.

The present disclosure relates to a method of aligning elongate susceptor elements in an aerosol-forming substrate for use in an inductively heatable aerosol-generating article. The present disclosure further relates to an apparatus for aligning elongate susceptor elements in an aerosol-forming substrate, in particular for use in a method according to the present disclosure.

Aerosol-generating systems using induction heating for generating inhalable aerosols are generally known from prior art. Such systems may comprise an inductively heating aerosol-generating device and a separate aerosol-generating article for use with the device. Among other components, the article may include an aerosol-forming substrate capable to form an inhalable aerosol when heated, and an inductively heatable susceptor arrangement in thermal proximity or direct physical contact with the substrate for heating the same. Inductive heating of the susceptor arrangement is accomplished by interaction of the susceptor arrangement with an alternating magnetic field that is provided by the aerosol-generating device. In operation, the alternating magnetic field induces at least one of heat-generating eddy currents or hysteresis losses in the susceptor arrangement, causing the latter to heat up to a temperature sufficient to release volatile compounds from the heated substrate, which subsequently can cool down to form an aerosol.

Depending on the type of substrate and the shape of the article, different configurations of susceptor element susceptor arrangements are known. As an example, the article may comprise a single solid susceptor element, such as a susceptor strip, that is embedded in a solid or gel-like aerosol-forming substrate within a substrate portion of the article. While solid susceptor element are easily available at low cost, they form a single central heat source which can result in inhomogeneous temperature distribution over the substrate portion. This is because direct heating of the substrate only occurs in the immediate vicinity of the susceptor element, while peripheral regions of the substrate portions are heated only indirectly by means of heat conduction across adjacent substrate layers. In particular, the high temperature gradient may cause the inner regions of the substrate portion in the vicinity of the susceptor element to overheat, whereas the temperature in the peripheral regions of the substrate portion may be too low for volatilizing the substrate. Moreover, the heating efficiency of this configuration is rather sensitive to a proper positioning of the susceptor element within the substrate. All this may cause a non-optimal exploitation of the aerosol-forming substrate. Alternatively, articles have been proposed that comprise spherical or quasi-spherical susceptor particles homogenously disturbed throughout the aerosol-forming substrate. Whilst leading to a more homogenous heating of the substrate, the heating efficiency of this susceptor configuration is limited which may also impact the extraction efficiency. Another alternative is to provide elongated susceptor elements distributed throughout the aerosol-forming substrate or deposited on a main surface of the aerosol-forming substrate. While this leads to a more uniform heating of the aerosol-forming substrate it has been discovered that a proper alignment of the elongated susceptor elements with respect to the alternating magnetic field applied may further increase the heating efficiency.

Therefore, it would be desirable to have an inductively heatable aerosol-forming substrate and an apparatus for manufacturing such an aerosol-forming substrate with the advantages of prior art solutions, whilst mitigating their limitations. In particular, it would be desirable to have an aerosol-forming substrate comprising elongated susceptor elements that are at least partially aligned for providing a more efficient heating and exploitation of the aerosol-forming substrate.

According to an aspect of the present disclosure, there is provided a method of aligning elongate susceptor elements in or on an aerosol-forming substrate for use in an inductively heatable aerosol-generating article. The method comprises the step of providing an aerosol-forming substrate in the form of a sheet material, the aerosol-forming substrate comprising a plurality of elongate susceptor elements. The sheet material is then arranged close to a magnetic alignment device in a subsequent step. An aligning magnetic field is then applied to the aerosol-forming substrate by means of the magnetic alignment device, wherein the aligning magnetic field causes the elongate susceptor elements to be attracted and aligned along the aligning magnetic field at least partially with respect to a reference axis of the sheet material.

As used herein, the term “elongate susceptor element” refers to a susceptor element having a greater extent in one predominant dimension than in the two remaining dimensions perpendicular to the predominant dimension. As such, the elongate susceptor element may also be denoted as 1D-elongate susceptor element (synonym for one-dimensionally-elongate susceptor element) or quasi-1D susceptor element (synonym for quasi-one-dimensional susceptor element). In particular, the term “elongate susceptor element” may refer to a susceptor element that has a length dimension greater than any transverse dimension perpendicular to the length dimension. More particularly, the 1D-elongate susceptor element may be an elongate or a prolate susceptor element.

Although the present invention is described herein with respect to elongate susceptor elements having a length dimension greater than any transverse dimension perpendicular to the length dimension, that is, with respect to 1D-elongate susceptor element having a greater extent in one predominant dimension than in the two remaining dimensions perpendicular to the predominant dimension, it equally applies to susceptor elements having a greater extent in two (perpendicular) predominant dimensions than in the remaining dimension perpendicular to the predominant dimensions. Such susceptor elements may also be denoted as 2D-elongate susceptor elements. In particular, the present invention equally applies to susceptor elements which have a length dimension and a width dimension greater than a thickness direction, wherein the length dimension may be either greater than or substantially similar to the width dimension. More particularly, the present invention equally applies to susceptor elements which have one of an oblate cylindrical shape, such as coin shape, or an oblate-ellipsoidal shape, such as a lens shape, or a flake shape or plate shape. For these susceptor elements, the same features and advantages as described herein with respect to (1D-)elongate susceptor element equally apply and can be equally formulated by basically replacing the term “maximum length dimension of the (1D-)elongate susceptor element(s)” by “maximum extent of the 2D-elongate susceptor element(s) in the two predominant dimensions” and “maximum transverse dimension of the (1D-)elongate susceptor element(s)” by a “maximum extent of the 2D-elongate susceptor element(s) in the remaining (non-prominent) dimension”.

As compared to a single solid susceptor element, usage of a plurality of elongate susceptor elements which are dispersed throughout the aerosol-forming substrate advantageously results in a more homogenous heat distribution over the substrate without any significant temperature gradients across different substrate regions. Furthermore, where the susceptor material of the susceptor elements has a high thermal conductivity, the homogeneity of the heat distribution is further enhanced by the fact that a substrate comprising a plurality of susceptor elements dispersed therein exhibits an increased equivalent thermal conductivity as compared to a substrate without susceptor elements or with a single solid susceptor element only. Moreover, in achieving a homogeneous heat distribution, the proposed susceptor arrangement is less sensitive to the positioning of the susceptor elements as compared to a single solid susceptor element.

Most important, it was found that the geometry, in particular the relative dimensions of the susceptor elements have a major impact on the heating efficiency and thus on the extraction efficiency of the substrate. In this regard, it was found that susceptor elements having an elongate shape are less prone to demagnetization effects as compared to rather equidimensional susceptor elements, such as spherical or quasi-spherical susceptor particles. This can be explained as follows: When placing a susceptor element in an external magnetic field, it becomes progressively magnetized. As the external field increases, so does the internal magnetization. This process continues until the magnetization reaches the magnetic saturation point of the material, beyond which no further magnetization can occur. As a result, the magnetization of the susceptor element causes an accumulation of magnetic charge density at opposite ends of the susceptor element as seen in the direction of the external magnetic field. As a consequence, the susceptor element generates a magnetic field that causes a self-interaction with its material. This field lies along the same direction as the external magnetic field, but points opposite to it, and thus is termed the demagnetization field. The demagnetizing field depends on the geometrical shape of the susceptor element, but not on its absolute dimensions. Provided the susceptor element responds to the external magnetic field changes, the demagnetizing field is generally assumed to be proportional to the magnetization in each direction, related by a geometry dependent constant of proportionality that is known as the demagnetization factor. The demagnetization factor depends on the shape of the susceptor element as well as on its relative orientation to the external magnetic field. To this extent, it has been found that an external magnetic field running through an elongate susceptor element, such as a susceptor element having the shape of a fiber or a thin rod, with a length dimension significantly greater than any transverse dimension perpendicular to the length dimension, generates a weaker or even negligible demagnetization field as compared to a non-elongate (equidimensional) susceptor element, such as a spherical or quasi-spherical susceptor element. This can be intuitively understood since in a properly aligned elongate susceptor element the accumulated magnetic charge densities at the opposite ends of the susceptor element are more spatially distanced from each other. This causes the demagnetizing field to significantly reduce its intensity and thus to have a lesser impact on the magnetization field, which is responsible for the power losses. As a result, power losses and thus heating efficiency is greater than for an elongate susceptor element than for a non-elongate (equidimensional) susceptor element, such as spherical or quasi-spherical susceptor element. This applies especially where the orientation of the magnetic field is substantially parallel to the length dimension of the elongate susceptor element, in which configuration the heating performance is at maximum. Yet, it has been found that the elongate susceptor elements do not necessarily need to be in perfect parallel alignment with the external magnetic field direction. Even if the susceptor elements are aligned in a certain angular range about the orientation of the external magnetic field, the overall heating performance is still higher than for a susceptor arrangement with randomly oriented susceptor elements.

As cited above, the aerosol-forming substrate comprises a plurality of elongate susceptor elements. Preferably, the elongate susceptor elements may be deposited on a main surface of the sheet material prior to or during applying the aligning magnetic field to the aerosol-forming substrate comprising the elongate susceptor elements.

In order to increase adhesion of the elongate susceptor elements to the main surface of the sheet material, a sticky agent may be applied to the main surface of the sheet material. The sticky agent may be applied prior to depositing the susceptor elements thereon. Alternatively, the sticky agent may be applied to the main surface of the sheet material after at least partially aligning the elongate susceptor elements. The sticky agent may therefore advantageously avoid displacement of the at least partially aligned elongate susceptor elements during subsequent processing of the sheet material. Preferably, the sticky agent comprises glycerol.

Displacement of the elongate susceptor elements may be also avoided, alternatively or additionally to applying a sticky agent, by at least partially embedding the elongate susceptor elements into the sheet material, for example by means of pressing devices and/or rollers.

Alternatively or additionally, the elongate susceptor elements may be dispersed throughout the aerosol-forming substrate provided as a sheet material. In this case, the aerosol-forming substrate may be provided with a viscosity that allows the elongate susceptor elements dispersed therethrough to move and at least partially align when subjected to the aligning magnetic field. Preferably, the aerosol-forming substrate is dried, hardened and/or cured after at least partially aligning the elongate susceptor elements in order to avoid displacement of the elongate susceptor elements during subsequent processing of the sheet material.

The method may comprise providing the aerosol-forming substrate comprising the plurality of elongate susceptor elements to or past the magnetic alignment device. The method may comprise conveying the aerosol-forming substrate comprising the plurality of elongate susceptor elements to the magnetic alignment device.

The method may comprise supplying the elongate susceptor elements to the aerosol-forming substrate upstream of the magnetic alignment device.

Since the overall heating performance of the elongate susceptor elements increases with a decreasing deviation from an alignment substantially parallel to the alternating magnetic field used for induction heating, the elongate susceptor elements may be aligned preferably such that an angle between the length dimension of the elongate susceptor elements and the reference axis is in a range between +30 degrees and −30 degrees, preferably between +25 degrees and −25 degrees, in particular between +10 degrees and −10 degrees. Therefore, an aerosol-forming substrate with increased heating performance may be provided. As used herein, the terms “(at least) partial alignment” or “(at least) partially aligned” refer to this kind of alignment in the above-defined angular ranges.

As stated above, the heating performance is at maximum for a substantially parallel alignment. Accordingly, the elongate susceptor elements are preferably aligned substantially parallel to the reference axis. As used herein, the term “substantially parallel” is understood as “parallel +5° degrees deviation from a parallel arrangement”.

The reference axis of the sheet material may be parallel to the sheet material.

In general, the elongate susceptor elements may be even randomly oriented within the aerosol-forming substrate, although the overall heating performance is lower for a random orientation than for an ensemble of elongate susceptor elements which are aligned in a certain angular range or substantially in parallel to the alternating magnetic field. This is because when considering an ensemble of susceptor elements, the overall heating performance of an ensemble of randomly oriented elongate susceptor elements is still higher on statistical average than that of an ensemble of non-elongate susceptor elements.

With a method (and an apparatus) according to the present disclosure, there is provided a method/apparatus that allows to easily at least partially align the elongate susceptor elements deposited on a main surface of the sheet material and/or dispersed throughout the aerosol-forming substrate provided as a sheet material, therefore allowing for the manufacturing of an inductively heatable aerosol-generating article with increased heating performance.

Whenever in this disclosure a number or a range is given for a plurality of a objects, such as for the plurality of susceptor elements, this means that the number or the range applies to at least 60 percent, in particular at least 70 percent, more particularly at least 80 percent, especially at least 90 percent of all objects out of the plurality of objects, preferably for all objects out of the plurality of objects. For example, where the present disclosure states that the elongate susceptor elements are aligned such that an angle between the length dimension of the elongate susceptor elements and the reference axis is in a range between +A degrees and −A degrees, this means that at least 60 percent, in particular at least 70 percent, more particularly at least 80 percent, especially at least 90 percent of all elongate susceptor elements are aligned such that an angle between the length dimension of the elongate susceptor elements and the reference axis is in a range between +A degrees and −A degrees.

The throughput of a method according to the present disclosure may be increased by moving the magnetic alignment device and the sheet material relative to each other during alignment of the elongate susceptor elements, therefore allowing to at least partially align the elongate susceptor elements over a large portion of the sheet material. This is in particular advantageous when the sheet material is provided as a continuous substrate sheet.

In particular, during alignment of the elongate susceptor elements, the sheet material may be moved relative (in particular past) to the magnetic alignment device in a conveying direction, either continuously or stepwise. The conveying direction preferably being parallel to a plane defined by the sheet material or parallel to a plane tangent to the sheet material at a place of alignment.

As used herein, the term “place of alignment” refers to the current (surface) portion of the sheet material where the elongate susceptor element are subjected to the aligning magnetic field provided by the magnetic alignment device.

Preferably, the conveying direction may be substantially parallel to the reference axis of the sheet material. Therefore, a sheet material with at least partially aligned elongate susceptor elements with respect to both the reference axis and the conveying direction may be provided, in particular by providing the sheet material as a continuous substrate sheet, thereby allowing to increase the alignment performance when using a method according to the present disclosure.

Movement of the sheet material relative to (in particular past) the aligning magnetic device, either continuously or stepwise, in the conveying direction may be achieved by means of a substrate conveyor belt or one or more rollers.

The magnetic alignment device may be preferably arranged vertically below the sheet material at a place of alignment.

As used herein, the term “arranged vertically below” is understood as lying in a projection of a plane of the sheet material or a projection of a plane tangent to the sheet material at the place of alignment below the sheet material.

It has to be however understood that, according to the present disclosure, the magnetic alignment device may be arranged anywhere as long as the aligning magnetic field provided by the alignment magnetic device is arranged and oriented such as to attract and align the elongate susceptor elements with respect to the reference axis, that means the aligning magnetic field runs through the sheet material at the place of alignment to at least partially align the elongate susceptor elements.

Alignment of the elongate susceptor elements may be preferably achieved with a magnetic alignment device comprising at least one magnetic roller. A magnetic roller, as will be explained later in major detail, is a simple component that enables the provision of the aligning magnetic field in the desired direction and can be flexibly arranged depending on the needs and product characteristics. For example, the magnetic roller may be part of the substrate conveyor belt or be configured as a roller used for conveying the sheet material.

The magnetic roller may be a permanent-magnetic roller or an electro-magnetic roller, and may comprise one or more permanent magnets and/or one or more electromagnets. The plurality of magnets may be arranged fixedly or may rotate, in particular rotate together with the magnetic roller at the same rotational speed.

In the case where the magnetic roller comprises a plurality of permanent magnets, the plurality of permanent magnets may be arranged circumferentially around a rotation axis of the magnetic roller within a perimeter of the magnetic roller.

Analogously, when the magnetic roller comprises a plurality of electromagnets, the plurality of permanent magnets may be arranged circumferentially around a rotation axis of the magnetic roller within a perimeter of the magnetic roller.

The at least partial alignment of the elongate susceptor elements may be in particular achieved with a configuration where the magnetic field on the outside of the magnetic roller extends at least partially circumferentially around the magnetic roller. In particular when a plurality of permanent magnets and/or electromagnets are comprised by the magnetic roller, the magnets may be configured such that the magnetic field extends at least partially circumferentially around the magnetic roller outside the magnetic roller. Preferably the plurality of permanent magnets and/or electromagnets may be configured such that the outmost poles of the magnets with respect to a radial direction of the magnetic roller have alternating north poles and south poles, that means, the magnets are arranged such that an outmost north pole of a magnet is followed by an outmost south pole of another magnet along a circumferential direction of the magnetic roller. In particular, neighboring magnets may have alternating outmost north and south poles. In the case where electro-magnets are used, the electromagnets may be configured such that and/or synchronized to a rotation of the magnetic roller in order to provide the aligning magnetic field only over a circumferential portion of the magnetic roller.

Alternatively, the at least partial alignment of the elongate susceptor elements may be achieved with a magnetic field on the outside of the magnetic roller extending in parallel to the rotation axis of the magnetic roller. In this case, the elongate susceptor elements are at least partially aligned perpendicular to the conveying direction, that is the reference axis is arranged perpendicular to the conveying direction. Accordingly, the elongate susceptor elements may be preferably at least partially aligned such that an angle between a length dimension of the elongate susceptor elements and a direction perpendicular to the conveying direction is in a range between +30 degrees and −30 degrees, preferably +25 degrees and −25 degrees, in particular between +10 degrees and −10 degrees. Preferably, the elongate susceptor elements may be aligned substantially parallel to each other and perpendicular to the conveying direction.

A width of the sheet material may be larger than a width of the elongate susceptor elements. A width of the sheet material may be at least 1 centimeter, or at least 5 centimeters, or at least 10 centimeters, or at least 15 centimeters, for example.

For aligning the elongate susceptor elements over the whole width of the sheet material, the magnetic alignment device may be configured such that its lateral dimension substantially corresponds to a lateral dimension of the sheet material.

The aligning magnetic field may be applied to the sheet material either continuously or intermittently and with a constant or pulsed magnetic field strength and/or flux density. For example, the magnetic alignment device may comprise a permanent-magnetic roller, thereby continuously providing an alignment magnetic field. The magnetic alignment device may also comprise an electro-magnetic roller configured to continuously provide the alignment magnetic field or configured to intermittently provide the alignment magnetic field. In yet another example, the magnetic alignment device may comprise at least two electromagnets, and the aligning magnetic field may be generated between the at least two electromagnets in an intermittent or pulsed manner, preferably synchronized to a conveying speed of the sheet material moving relative to the magnetic alignment device. This is in particular advantageous to avoid displacement of the at least partially aligned elongate susceptor elements when they are moving out of the aligning magnetic field.

The aerosol-forming substrate may be preferably made from a substrate slurry casted into the form of the sheet material, wherein the elongate susceptor elements may be deposited on the main surface of the sheet material and/or may be dispersed throughout the sheet material., in particular prior to drying the casted substrate slurry. Depending on the firmness of the casted substrate slurry, the elongate susceptor elements may be at least partially embedded within the substrate sheet after or during deposition prior to the alignment step.

As already cited above, the aerosol-forming substrate in the form of the sheet material may be a continuous substrate sheet, therefore enabling continuous alignment of the elongate susceptor elements on/in the continuous substrate sheet and increasing the throughput of the method according to the present disclosure.

To further improve manufacturing of the aerosol-forming substrate, the elongate susceptor elements may be aligned during or after crimping the continuous substrate sheet, in particular during or after crimping the continuous substrate sheet in a longitudinal direction. The longitudinal direction may be a machine direction of the continuous substrate sheet, preferably parallel to the conveying direction. Crimping may be preferably performed by passing the sheet material between corrugated crimping rollers. Alignment of the elongate susceptor elements during or after crimping has the advantage that, since the sheet material is corrugated, the created corrugations may facilitate alignment of the elongate susceptor elements or even provide a pre-alignment of the elongate susceptor elements, in particular when the elongate susceptor elements are deposited on the main surface of the sheet material during or after crimping such that they can arrange themselves in the corrugations created during crimping.

As discussed above, the geometry, in particular the relative dimensions of the elongate susceptor elements have a major impact on the heating efficiency and thus on the extraction efficiency of the substrate. Therefore, the elongate susceptor elements may be selected such as having a ratio of a length dimension to a maximum transverse dimension greater than 4, in particular greater than 10, preferably greater than 20, more preferably greater than 25, even more preferably greater than 30, most preferably greater than 35. The term “maximum transverse dimension” as used herein refers to a greatest dimension of the elongate susceptor element perpendicular to the predominant dimension (length dimension). This ratio may also be denoted as aspect ratio or form factor.

As used herein, the ratio of the maximum length dimension of an elongate susceptor element to the maximum transverse dimension of the elongate susceptor element perpendicular to the length dimension is also denoted as form factor or aspect ratio. Accordingly, the form factor of the elongate susceptor elements is greater than 4, in particular greater than 10, preferably greater than 20, more preferably greater than 25, even more preferably greater than 30, most preferably greater than 35.

Preferably, the ratio of the maximum length dimension to the maximum transverse dimension (the form factor) does not only have a lower limit but also an upper limit. Accordingly, the ratio of the maximum length dimension to the maximum transverse dimension of the elongate susceptor elements perpendicular to the (maximum) length dimension, that is, the form factor of the elongate susceptor elements may be a range between 4 and 500, in particular between 10 and 300, preferably between 20 and 200, more preferably between 30 and 100.

In absolute values, a length dimension of the elongate susceptor elements may be in a range between 20 micrometer and 50 millimeters, in particular 100 micrometer and 16 millimeter, preferably between 0.5 millimeter and 5 millimeter. Such maximum length dimensions prove advantageous with regard to alignment according to the present disclosure.

Depending on the respective absolute values of the maximum length dimension, the respective absolute value of the maximum transverse dimension of the elongate susceptor elements is preferably chosen such that the form factor is above the above-defined lower limit, advantageously also within the above-defined preferred ranges. Accordingly, a maximum transverse dimension of the elongate susceptor elements may be in a range between 5 micrometer and 500 micrometer, in particular 10 micrometer and 150 micrometer, preferably 80 micrometer and 120 micrometer. In particular, a maximum transverse dimension of the elongate susceptor elements may be equal to or smaller than 500 micrometer, in particular 100 micrometer, preferably 50 micrometer, more preferably 25 micrometer.

The heating efficiency also depends on the density of the elongate susceptor elements within the aerosol-forming substrate. The higher the density, the larger the heating efficiency. Preferably, a (volume) density of the elongate susceptor elements within the aerosol-forming substrate is in a range between 0.001 susceptor elements per cubic millimeter and 30 susceptor elements per cubic millimeter, in particular between 0.1 susceptor elements per cubic millimeter and 10 susceptor elements per cubic millimeter. Likewise, a mass density of the elongate susceptor elements within the aerosol-forming substrate may be in a range between 0.002 milligram of susceptor mass per cubic millimeter and 0.3 milligram susceptor mass per cubic millimeter, in particular between 0.01 milligram of susceptor mass per cubic millimeter and 0.1 milligram of susceptor mass per cubic millimeter.

In general, the susceptor elements may have any geometrical shape, as long as it is elongate. In particular, the elongate susceptor elements may have one of a cylindrical shape or a prolate-ellipsoidal shape. That is, the elongate susceptor elements may have a rod-like shape or a grain-like shape.

As an example, the elongate susceptor elements may be fiber elements, in particular chopped fiber elements or milled fiber elements. As another example, the elongate susceptor elements may be wire elements or thread elements or grain elements or rod elements. Advantageously, the fiber elements or the wire elements or the thread elements or the grain elements or the filament elements or the rod elements are made of a material that is inductively heatable, such as metal fibers, or metal wires or metal threads, which are easily available at low cost.

As seen in a plane perpendicular to the length dimension of the elongate susceptor element, a cross-section of the elongate susceptor elements may have a circular shape or an oval shape or an elliptical shape or a triangular shape or a rectangular shape or a quadratic shape or polygonal shape. If the cross-section is circular, the above-mentioned maximum transverse dimension of the elongate susceptor elements corresponds to the diameter of the susceptor elements where it is at maximum along the length dimension of the elongate susceptor elements. If the cross-section is oval or elliptical, the above-mentioned maximum transverse dimension of the susceptor elements corresponds to the length of the semimajor axis of the oval or elliptical cross-section, where it is at maximum along the length dimension of the elongate susceptor elements. If the cross-section is quadratic or in general rectangular, the above-mentioned maximum transverse dimension of the susceptor elements corresponds to the length of the edge/major edge of the quadratic/rectangular cross-section.

In general, the term “susceptor element” as used herein refers to an element comprising a susceptor material that is capable to convert electromagnetic energy into heat when subjected to an alternating magnetic field. This may be the result of at least one of hysteresis losses and eddy currents induced in the susceptor material, depending on the electrical and magnetic properties of the susceptor material. Hysteresis losses occur in ferromagnetic or ferrimagnetic susceptor materials due to magnetic domains within the material being switched under the influence of an alternating electromagnetic field. Eddy currents may be induced, if the susceptor material is electrically conductive. In case of an electrically conductive ferromagnetic susceptor or an electrically conductive ferrimagnetic susceptor, heat can be generated due to both, eddy currents and hysteresis losses.

Accordingly, the elongate susceptor elements may be in general at least one of electrically conductive and either ferromagnetic or ferrimagnetic. In particular, the susceptor material of the elongate susceptor elements may be electrically non-conductive, but either ferromagnetic or ferrimagnetic. Alternatively, the susceptor material of the elongate susceptor elements may be electrically conductive, but neither ferromagnetic nor ferrimagnetic.

Preferably, the susceptor material of the elongate susceptor elements may comprises or consists of a metal, for example ferritic iron, or stainless steel, in particular a grade 410, grade 420, or grade 430 stainless steel; or a ferrimagnetic ceramic.

In addition to the susceptor material, the elongate susceptor elements may further comprise a ferromagnetic or ferrimagnetic temperature marker material.

While the susceptor material is optimized with regard to heat loss and thus heating efficiency, the temperature marker material is a magnetic (ferro-or ferrimagnetic) material that is chosen such as to have a Curie temperature which essentially corresponds to a predefined temperature point of the heating process.

The temperature marker material may have a Curie temperature below 500° C., preferably equal to or below 400° C., in particular equal to or below 390° C. For example, the temperature marker material of the elongate susceptor elements may have a Curie temperature in a range between 180° C. and 420° C., in particular between 210° C. and 380° C., preferably between 250° C. and 380° C. Even though the temperature marker material primarily is a functional material providing a temperature marker by its Curie temperature, it may also contribute to the inductive heating process of the susceptor arrangement.

The temperature marker material of the elongate susceptor elements may comprise or may consist of nickel or a nickel alloy.

The susceptor elements may be formed such that the susceptor material is surrounded or covered at least partially, preferably entirely by the temperature marker material.

In addition, the elongate susceptor elements may comprise an outer protective coating surrounding the susceptor material an—if present—the temperature marker material. Preferably, the protective coating makes the elongate susceptor elements resistant to external influences, especially corrosive influences.

The provided elongate susceptor elements may have substantially identical characteristics such as susceptor material, maximum extent, form ratio, temperature marker material, outer coating etc. Alternatively, a mixture of elongate susceptor elements with different characteristics may be provided.

It is also possible that the susceptor material of the susceptor elements itself has a temperature marker function. That is, the elongate susceptor elements may comprise a single material which acts both as a susceptor material and as a temperature marker material.

According to another aspect of the present disclosure, there is provided a method for manufacturing aerosol-generating segments for use in an inductively heatable aerosol-generating article. The method for manufacturing aerosol-generating segments comprises the method of aligning elongate susceptor elements in or on an aerosol-forming substrate as described herein. The sheet material is gathered into a rod downstream of the magnetic alignment device. The rod is cut into segments, wherein each segment comprises multiple susceptor elements.

The multiple susceptor elements may comprise at least 5 susceptor elements, or at least 10 susceptor elements, or at least 20 susceptor elements, or at least 50 susceptor elements, for example.

Gathering the sheet material into the rod may comprise conveying the sheet material through a shaping device. The shaping device may have a funnel-shape.

The present disclosure also relates to an apparatus for aligning elongate susceptor elements in or on an aerosol-forming substrate. The apparatus may be in particular suited for use in a method according to the present disclosure. Therefore, the above description applies accordingly to the apparatus according to the present disclosure.

The apparatus may comprise a magnetic alignment device configured for generating and applying an aligning magnetic field to an aerosol-forming substrate comprising elongated susceptor elements. The aerosol-forming substrate is provided as a sheet material. When applied to the sheet material comprising the elongate susceptor elements, the aligning magnetic field causes the elongate susceptor elements to be attracted and aligned along the aligning magnetic field at least partially with respect to a reference axis of the sheet material.

The elongate susceptor elements may be preferably provided and supplied to the aerosol-forming substrate via a susceptor supply upstream of the magnetic alignment device. The susceptor supply may be in particular a hopper.

The aerosol-forming substrate in the form a sheet material may be preferably provided via a substrate supply to or past the magnetic alignment device. The substrate supply may be preferably configured to provide the sheet material vertically above the magnetic alignment device.

The substrate supply may preferably comprise a conveyor belt or one or more rollers for providing the aerosol-forming substrate in the form the sheet material to and/or past the magnetic alignment device in a conveying direction, either continuously or stepwise. The conveying direction may be preferably parallel to a plane defined by the sheet material or parallel to a plane tangent to the sheet material at a place of alignment.

The magnetic alignment device may comprise at least one magnetic roller, which may be a permanent-magnetic roller or an electromagnetic roller, and may comprise one or more permanent magnets and/or one or more electromagnets.

In a preferred configuration, the magnetic roller may comprise a plurality of permanent magnets arranged circumferentially around a rotation axis of the magnetic roller within a perimeter of the magnetic roller and/or a plurality of electromagnets arranged circumferentially around a rotation axis of the magnetic roller within a perimeter of the magnetic roller.

The magnetic field on the outside of the magnetic roller may preferably extend at least circumferentially around the magnetic roller. Alternatively, the magnetic field on the outside of the magnetic roller may extend at least partially in parallel to a rotation axis of the magnetic roller.

As used herein, the term “aerosol-generating article” refers to an article comprising at least one aerosol-forming substrate that is capable of releasing volatile compounds when heated in order to form an aerosol. The aerosol-generating article may be a consumable, in particular a consumable to be discarded after a single use. For example, the article may be an elongate article or a rod-shaped article. The elongate or rod-shaped article may have a shape resembling the shape of conventional cigarettes. In particular, such an article may have a circular or elliptical or oval or square or rectangular or triangular or a polygonal cross-section.

As used herein, the term “aerosol-forming substrate” denotes a substrate formed from or comprising an aerosol-forming material that is capable of releasing volatile compounds upon heating in order to generate an aerosol. Preferably, the aerosol-forming substrate is intended to be heated rather than combusted in order to release the aerosol-forming volatile compounds. Accordingly, such a substrate may be denoted as a heat-not-burn aerosol-forming substrate. Likewise, an aerosol-generating article comprising such an aerosol-forming substrate may be denoted as a heat-not-burn aerosol-generating article.

In general, the aerosol-forming substrate may comprise at least one aerosol former and at least one sensorial material both of which are volatilizable when heated. The sensorial material may comprise at least one of a tobacco-containing material, a nicotine-containing material and a flavoring substance. Examples of suitable aerosol formers are glycerin and propylene glycol. Examples of flavoring substance may be plant extracts and natural or artificial flavors.

The aerosol-forming substrate may be a solid aerosol-forming substrate, a gel-like aerosol-forming substrate, or any combination thereof.

As mentioned above, the aerosol-forming substrate may comprise a tobacco-containing material containing volatile tobacco flavor compounds, which are released from the substrate upon heating. In particular, the aerosol-forming substrate may comprise reconstituted tobacco material or a tobacco-containing slurry. Accordingly, the aerosol-generating article may be a tobacco containing article. Alternatively or additionally, the aerosol-forming substrate may comprise a non-tobacco material. The aerosol-forming substrate may also comprise other additives and ingredients, such as nicotine or flavourants.

The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

The aerosol-forming substrate is made from a sheet material. For example, the aerosol-forming substrate may be made from a crimped tobacco sheet comprising a tobacco material, organic fibers, a binder, an aerosol former. Alternatively, the aerosol-forming substrate may be made from a sheet material including a nicotine-containing material, organic fibers, a binder, an aerosol former. As yet another alternative, the aerosol-forming substrate may be made from a sheet material containing tobacco cut filler. To this extent, it has been found that the aerosol-generating article is easy to manufacture, especially with respect to a preferred alignment of the elongate susceptor elements relative to a pre-defined reference axis of the article, if the elongate susceptor elements are applied to the aerosol-forming substrate and aligned when it is in the form of a sheet material. This may be the result of a manufacturing process including the deposition of the elongate susceptor elements on an outer surface of a sheet material and/or dispersing the elongate susceptor elements within the sheet material, either during a primary process, in which the sheet material is produced, or, in the case where the elongate susceptor elements are deposited on the main surface of the sheet-material, during a secondary process, where the sheet material is machined and combined with other semi-finished goods to obtain the final product. As a result of this, the elongate susceptor elements may be finally disposed in at least partial alignment to each other and to a reference axis of the sheet material on an outer surface of the sheet material, at least partially embedded in the sheet material close to an outer surface of the sheet material or dispersed throughout the sheet material. This can be observed even if the sheet material is subsequently machined, for example, crimped and gathered such as to form a substrate plug in the final article.

The invention is defined in the claims. However, below there is provided a non-exhaustive list of non-limiting examples. Any one or more of the features of these examples may be combined with any one or more features of another example, embodiment, or aspect described herein.

Example Ex1: A method of aligning elongate susceptor elements in or on an aerosol-forming substrate for use in an inductively heatable aerosol-generating article, the method comprising the steps of: providing an aerosol-forming substrate in the form of a sheet material, the aerosol-forming substrate comprising a plurality of elongate susceptor elements; arranging the sheet material close to a magnetic alignment device; applying an aligning magnetic field to the aerosol-forming substrate by means of the magnetic alignment device, the aligning magnetic field causing the elongate susceptor elements to be attracted and aligned along the aligning magnetic field at least partially with respect to a reference axis of the sheet material.

Example Ex2: The method according to Example Ex1, wherein the elongate susceptor elements are deposited on a main surface of the sheet material.

Example Ex3: The method according to Example Ex1 or Ex2, wherein a sticky agent is applied to the main surface of the sheet material prior to depositing the elongate susceptor elements thereon, or is applied after at least partially aligning the elongate susceptor elements.

Example Ex4: The method according to Example Ex3 wherein the sticky agent comprises glycerol.

Example Ex5: The method according to Example Ex1, wherein the elongate susceptor elements are dispersed throughout the aerosol-forming substrate provided as a sheet material.

Example Ex6: The method according to any one of the preceding Examples, wherein the elongate susceptor elements are aligned at least partially such that an angle between a length dimension of the elongate susceptor elements and the reference axis is in a range between +30 degrees and −30 degrees, preferably +25 degrees and −25 degrees, in particular between +10 degrees and −10 degrees.

Example Ex7: The method according to any one of the preceding Examples, wherein the elongate susceptor elements are aligned substantially parallel to each other and to the reference axis.

Example Ex 8: The method according to any one of the preceding Examples, wherein during alignment of the elongate susceptor elements, the magnetic alignment device and the sheet material are moved relative to each other.

Example Ex9: The method according to any one of the preceding Examples, wherein during alignment of the elongate susceptor elements, the sheet material is moved relative (in particular past) to the magnetic alignment device in a conveying direction, the conveying direction preferably being parallel to a plane defined by the sheet material or parallel to a plane tangent to the sheet material at a place of alignment.

Example Ex10: The method according to Example Ex9, wherein the conveying direction is substantially parallel to the reference axis.

Example Ex11: The method according to any one of Examples Ex9 or Ex10, wherein the sheet material is moved relative to (in particular past) the magnetic alignment device in the conveying direction by means of a substrate conveyor belt or by means of one or more rollers.

Example Ex12: The method according to any one of the preceding Examples, wherein the magnetic alignment device is arranged vertically below the sheet material at a place of alignment.

Example Ex13: The method according to any one of the preceding Examples, wherein the magnetic alignment device comprises at least one magnetic roller.

Example Ex14: The method according to Example Ex13, wherein the magnetic roller is a permanent-magnetic roller or an electro-magnetic roller.

Example Ex15: The method according to any one of Examples Ex13 or Ex14, wherein the magnetic roller comprises one or more permanent magnets and/or one or more electromagnets.

Example Ex16: The method according to any one of Examples Ex13 to Ex15, wherein the magnetic roller comprises a plurality of permanent magnets arranged circumferentially around a rotation axis of the magnetic roller within a perimeter of the magnetic roller.

Example Ex17: The method according to any one of the Examples Ex13 to Ex16, wherein the magnetic roller comprises a plurality of electromagnets arranged circumferentially around a rotation axis of the magnetic roller within a perimeter of the magnetic roller.

Example Ex18: The method according to any one of the Examples Ex13 to Ex17, wherein the magnetic field on the outside of the magnetic roller extends at least partially circumferentially around the magnetic roller.

Example Ex19: The method according to any one of the Examples Ex13 to Ex18, wherein the magnetic field on the outside of the magnetic roller extends at least partially in parallel to a rotation axis of the magnetic roller.

Example Ex20: The method according to any one of the preceding Examples, wherein a lateral dimension of the conveyor belt substantially corresponds to a lateral dimension of the sheet material.

Example Ex21: The method according to any one of the preceding Examples, wherein the aerosol-forming substrate is made from a substrate slurry casted into the form of the sheet material.

Example Ex22: The method according to Example Ex21, wherein the elongate susceptor elements are deposited on the main surface of the sheet material or dispersed throughout the sheet material prior to drying the casted substrate slurry.

Example Ex23: The method according to any one of the preceding Examples, wherein the aerosol-forming substrate in the form of the sheet material is a continuous substrate sheet.

Example Ex24: The method according to Example Ex24, wherein the elongate susceptor elements are at least partially aligned during or after crimping the continuous substrate sheet, especially during or after crimping the continuous substrate sheet in a longitudinal direction, in particular in a machine direction of the continuous substrate sheet.

Example Ex25: The method according to any one of the preceding Examples, wherein a ratio of a length dimension to a maximum transverse dimension of the elongate susceptor elements is greater than 4, in particular greater than 10, preferably greater than 20, more preferably greater than 25, even more preferably greater than 30, most preferably greater than 35.

Example Ex26: The method according to any one of the preceding Examples, wherein a ratio of the length dimension to a maximum transverse dimension of the elongate susceptor elements is in a range between 4 and 500, in particular between 10 and 300 preferably between 20 and 200, more preferably between 30 and 100.

Example Ex27: The method according to any one of the preceding Examples, wherein a length dimension of the elongate susceptor elements is in a range between 20 micrometer and 50 millimeter, in particular 100 micrometer and 16 millimeter, preferably between 0.5 millimeter and 5 millimeter.

Example Ex28: The method according to any one of the preceding Examples, wherein a maximum transverse dimension of the elongate susceptor elements is a range between 5 micrometer and 500 micrometer, in particular 10 micrometer and 150 micrometer, preferably 80 micrometer and 120 micrometer.

Example Ex29: The method according to any one of the preceding Examples, wherein a maximum transverse dimension of the elongate susceptor elements is equal to or smaller than 500 micrometer, in particular 100 micrometer, preferably 50 micrometer, more preferably 25 micrometer.

Example Ex30: The method according to any one of the preceding Examples, wherein the elongate susceptor elements have one of a cylindrical shape or a prolate-ellipsoidal shape.

Example Ex31: The method according to any one of the preceding Examples, wherein the elongate susceptor elements are one of fiber elements, in particular chopped fiber elements or milled fiber elements, or wire elements, or thread elements, or grain elements or rod elements.

Example Ex32: The method according to any one of the preceding Examples, wherein a cross-section of the elongate susceptor elements in a plane perpendicular to the length dimension of the susceptor element has a circular shape or an oval shape or an elliptical shape or a triangular shape or a rectangular shape or a quadratic shape or polygonal shape.

Example Ex33: The method according to any one of the preceding Examples, wherein the elongate susceptor elements comprise a susceptor material which is at least one of electrically conductive and either ferromagnetic or ferrimagnetic.

Example Ex34: The method according to Example Ex33, wherein the susceptor material of the elongate susceptor elements comprises or consists of a metal, for example ferritic iron, or stainless steel, in particular a grade 410, grade 420, or grade 430 stainless steel; or a ferrimagnetic ceramic.

Example Ex35: The method according to any one Examples Ex33 or Ex34, wherein the elongate susceptor elements further comprise a ferromagnetic or ferrimagnetic temperature maker material in addition to the susceptor material.

Example Ex36: The method according to Example Ex35, wherein the temperature maker material of the elongate susceptor elements comprises or consists of nickel or a nickel alloy.

Example Ex37: An apparatus for aligning elongate susceptor elements in or on an aerosol-forming substrate, in particular for use in a method according to any one of the preceding Examples, the apparatus comprising a magnetic alignment device configured for applying an aligning magnetic field to an aerosol-forming substrate comprising elongated susceptor elements, the aerosol-forming substrate being provided as a sheet material, the aligning magnetic field causing the elongate susceptor elements to be attracted and aligned along the aligning magnetic field at least partially with respect to a reference axis of the sheet material.

Example Ex38: The apparatus according to Example Ex38, further comprising a susceptor supply configured for providing and supplying elongate susceptor elements to the aerosol-forming substrate upstream of the magnetic alignment device.

Example Ex39: The apparatus according to any one of Examples Ex37 or Ex38, further comprising a substrate supply for providing an aerosol-forming substrate in the form a sheet material to or past the magnetic alignment device, in particular vertically above the magnetic alignment device.

Example Ex40: The apparatus according to Example Ex39, wherein the substrate supply comprises a substrate conveyor belt or one or more rollers for providing the aerosol-forming substrate in the form the sheet material to or past the magnetic alignment device in a conveying direction.

Example Ex41: The apparatus according to any one of the Examples Ex37 to Ex40, wherein the magnetic alignment device comprises at least one magnetic roller.

Example Ex42: The apparatus according to any one of Examples Ex37 to Ex41, wherein the magnetic roller is a permanent-magnetic roller or an electro-magnetic roller.

Example Ex43: The apparatus according to any one of Examples Ex37 to Ex42, wherein the magnetic roller comprises one or more permanent magnets and/or one or more electromagnets.

Example Ex44: The apparatus according to any one of Examples Ex37 to Ex43, wherein the magnetic roller comprises a plurality of permanent magnets arranged circumferentially around a rotation axis of the magnetic roller within a perimeter of the magnetic roller.

Example Ex45: The apparatus according to any one of Examples Ex37 to Ex44, wherein the magnetic roller comprises a plurality of electromagnets arranged circumferentially around a rotation axis of the magnetic roller within a perimeter of the magnetic roller.

Example Ex46: The apparatus according to any one of Example Ex37 to Ex45, wherein the magnetic field on the outside of the magnetic roller extends at least partially circumferentially around the magnetic roller; or wherein the magnetic field on the outside of the magnetic roller extends at least partially in parallel to a rotation axis of the magnetic roller.

Example Ex47: A method for manufacturing aerosol-generating segments for use in an inductively heatable aerosol-generating article, the method comprising: the method according to any one of Examples Ex1 to Ex36; gathering the sheet material into a rod downstream of the magnetic alignment device; and cutting the rod into segments, wherein each segment comprises multiple susceptor elements.

Examples will now be further described with reference to the figures in which:

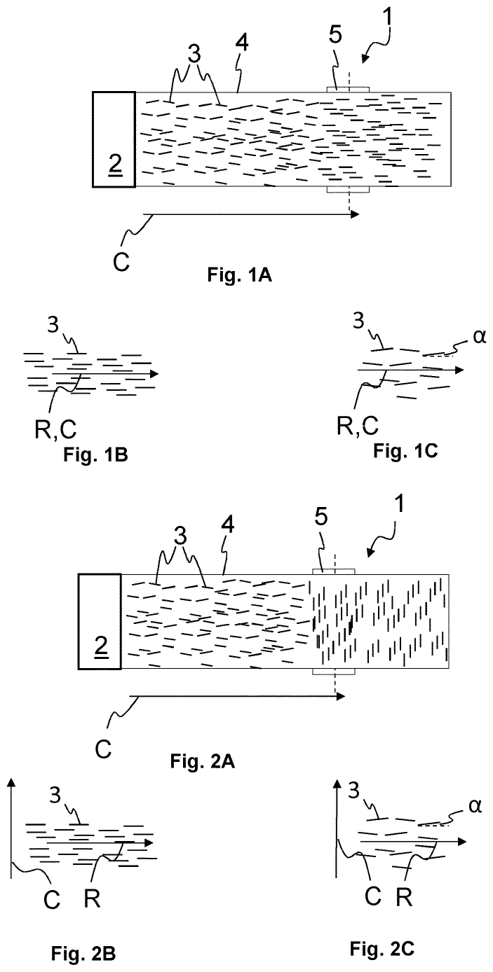

FIG. 1A schematically shows a magnetic alignment apparatus in top view according to the present invention;

FIG. 1B schematically shows a detail of aligned elongate susceptor elements;

FIG. 1C schematically shows a detail of partially aligned elongate susceptor elements;

FIG. 2A schematically shows a magnetic alignment apparatus in top view according to an embodiment of the present invention;

FIG. 2B schematically shows a detail of aligned elongate susceptor elements;

FIG. 2C schematically shows a detail of partially aligned elongate susceptor elements;

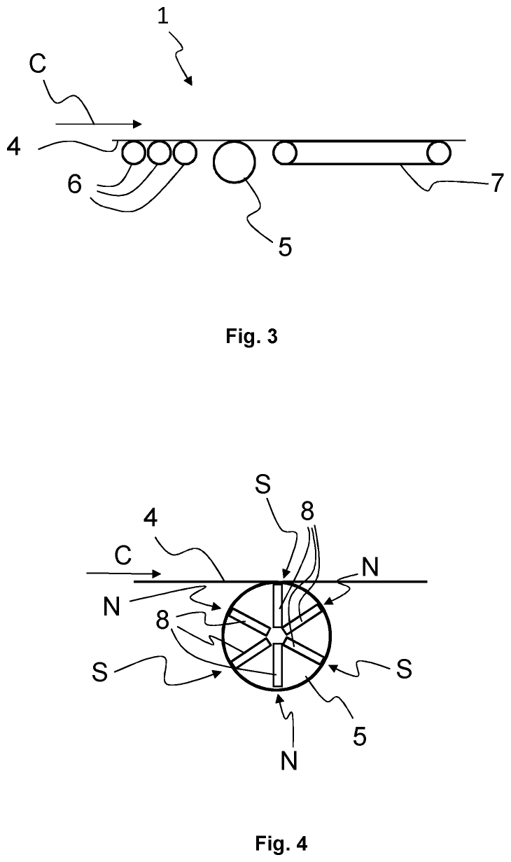

FIG. 3 schematically shows a magnetic alignment apparatus in lateral view according to the present invention;

FIG. 4 schematically shows a detail of a magnetic roller according to the present invention;

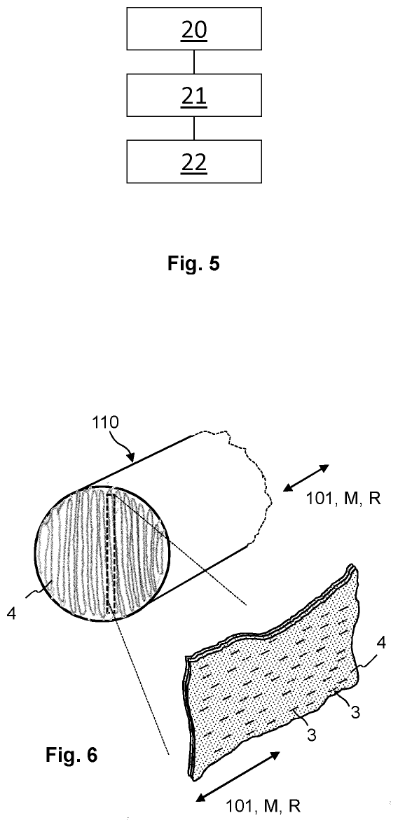

FIG. 5 schematically shows a flow chart of a method according to the present invention;

FIG. 6 schematically and in detail shows a substrate element comprising elongate susceptor elements;

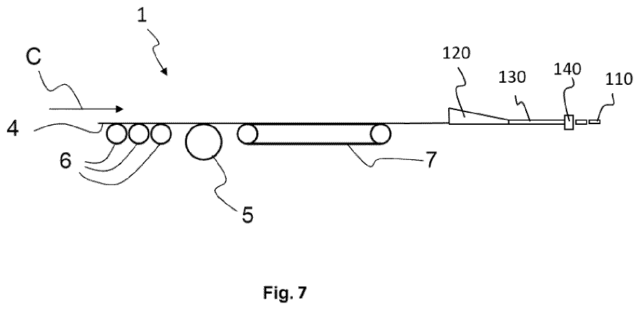

FIG. 7 schematically shows manufacturing a substrate element or segment.

All the examples shown in the figures are schematic and not to scale.

In FIG. 1A, an example of a magnetic alignment apparatus 1 is shown schematically in a top view. A susceptor supply 2 is arranged upstream of a magnetic alignment device comprising a magnetic roller 5 to provide elongate susceptor elements 3 to an aerosol-forming substrate provided as a sheet material 4. The magnetic roller 5 is arranged vertically below the sheet material 4, in the case of the top view of FIG. 1A below the plane of the sheet material 4. For the sake of clarity, in the example shown in FIG. 1A, the elongate susceptor elements 3 are shown as being deposited on a main surface of the sheet material 4 but, according to other possible examples, the elongate susceptor elements 3 may be dispersed throughout the aerosol-forming substrate provided as a sheet material 4. The sheet material 4 is conveyed in a conveying direction C by means of a susceptor supply which will be described later in more detail. The magnetic roller 5 is configured to generate an aligning magnetic field that causes the elongate susceptor elements 3 to which the aligning magnetic field is applied to be aligned along said aligning magnetic field. In the example shown in FIG. 1A, the elongate susceptor elements 3 are conveyed along the conveying direction C from left to right. Accordingly, the elongate susceptor elements 3 on the right side of FIG. 1A are aligned substantially parallel to each other, as compared to the elongate susceptor elements 3 on the left side of FIG. 1A. The magnetic alignment apparatus 1 may be configured such that the sheet material 4 is conveyed stepwise and the aligning magnetic field is generated by the magnetic roller 5 intermittently. In this case, the elongate susceptor elements 3 are conveyed to a place of alignment and the aligning magnetic field is applied to the elongate susceptor elements 3 for aligning them. The aligning magnetic field 5 is then turned off, and the sheet material 4 is conveyed further in the conveying direction C until the next portion of non-aligned elongate susceptor elements 3 is arranged at a place of alignment, and the process is repeated. Preferably, however, the magnetic alignment apparatus 1 is configured such that the sheet material 4, which is preferably a continuous substrate sheet, is continuously conveyed in the conveying direction C past the magnetic roller 5 where the elongate susceptor elements 3 are aligned by the aligning magnetic field generated by the magnetic roller 5. The aligning magnetic field generated by the magnetic roller 5 extends at least partially circumferentially around the magnetic roller 5 in the example shown in FIG. 1A, and the elongate susceptor elements 3 are aligned substantially parallel to each other and to a reference axis R of the sheet material 4, the reference axis R being parallel to the conveying direction C, as shown in detail in FIG. 1B. In this case, the elongate susceptor elements 3 may be also aligned substantially parallel to a projection of the conveying direction C onto a plane tangent to the sheet material 4 at a place of alignment.

Alternatively, as shown in the detail of FIG. 1C, the elongate susceptor elements 3 may be aligned in at least partial alignment, wherein an angle alpha (a) between a length dimension of the elongated susceptor elements 3 and the reference axis R, which is parallel to the conveying direction C, is in a range between +30 degrees and −30 degrees, in particular +25 degrees and −25 degrees, preferably between +10 degrees and −10 degrees. Accordingly, the elongate susceptor elements 3 may be aligned in a least partial alignment to a projection of the conveying direction C onto a plane tangent to the sheet material at a place of alignment.

FIG. 2A schematically shows another example of a magnetic alignment apparatus 1 in a top view. The magnetic alignment apparatus 1 shown in FIG. 2A substantially corresponds to the magnetic alignment apparatus 1 shown in FIG. 1A. A susceptor supply 2 is arranged upstream of a magnetic alignment device comprising a magnetic roller 5 to provide elongate susceptor elements 3 to an aerosol-forming substrate provided as a sheet material 4. The magnetic roller 5 is arranged vertically below the sheet material 4, in the case of the top view of FIG. 2A below the plane of the sheet material 4. For the sake of clarity, in the example shown in FIG. 2A, the elongate susceptor elements are shown as being deposited on a main surface of the sheet material 4 but, according to other possible examples, the elongate susceptor elements 3 may be dispersed throughout the aerosol-forming substrate provided as a sheet material 4. The sheet material 4 is conveyed in a conveying direction C by means of a susceptor supply which will be described later in more detail. The magnetic roller 5 is configured to generate an aligning magnetic field that causes the elongate susceptor elements 3 to which the aligning magnetic field is applied to be aligned along said aligning magnetic field. In the example shown in FIG. 2A, the elongate susceptor elements 3 are conveyed along the conveying direction C from left to right. Accordingly, the elongate susceptor elements 3 on the right side of FIG. 2A are aligned substantially parallel to each other, as compared to the elongate susceptor elements 3 on the left side of FIG. 2A. The magnetic alignment apparatus 1 may be configured such that the sheet material 4 is conveyed stepwise and the aligning magnetic field is generated by the magnetic roller 5 intermittently. In this case, the elongate susceptor elements 3 are conveyed to a place of alignment and the aligning magnetic field is applied to the elongate susceptor elements 3 for aligning them. The aligning magnetic field 5 is then turned off, and the sheet material 4 is conveyed further in the conveying direction C until the next portion of non-aligned elongate susceptor elements 3 is arranged at a place of alignment, and the process is repeated. Preferably, however, the magnetic alignment apparatus 1 is configured such that the sheet material 4, which is preferably a continuous substrate sheet, is continuously conveyed in the conveying direction C past the magnetic roller 5 where the elongate susceptor elements 3 are aligned by the aligning magnetic field generated by the magnetic roller 5. The aligning magnetic field generated by the magnetic roller 5 extends at least partially in parallel to a rotation axis of the magnetic roller 5 in the example shown in FIG. 2A, and the elongate susceptor elements 3 are aligned substantially parallel to each other and to a reference axis R of the sheet material 4, the reference axis R being perpendicular to the conveying direction C, as shown in detail in FIG. 2B. In this case, the elongate susceptor elements 3 may be also aligned substantially parallel to the reference axis and perpendicular to a projection of the conveying direction C onto a plane tangent to the sheet material 4 at a place of alignment.

Alternatively, as shown in the detail of FIG. 2C, the elongate susceptor elements 3 may be aligned in at least partial alignment, wherein an angle alpha (a) between a length dimension of the elongated susceptor elements 3 and the reference axis R, which is perpendicular to the conveying direction C, is in a range between +30 degrees and −30 degrees, in particular +25 degrees and −25 degrees, preferably between +10 degrees and −10 degrees. Accordingly, the elongate susceptor elements 3 may be aligned in a least partial alignment perpendicular to a projection of the conveying direction C onto a plane tangent to the sheet material at a place of alignment.

In FIG. 3, a schematic, simplified lateral view of a magnetic alignment apparatus 1 according to the present invention comprising the above cited substrate supply is shown. The sheet material 4 is conveyed in the conveying direction C parallel to a plane defined by the sheet material 4. The sheet material 4 may be conveyed by means or one or more rollers 6 and/or one or more conveyor belts 7 in the conveying direction C, either continuously or stepwise. The magnetic roller 5 is arranged vertically below the sheet material 4 and generates the aligning magnetic field for aligning the elongate susceptor elements 3 (not shown) passing over the magnetic roller 5, as explained above. The magnetic roller 5 may be a permanent-magnetic roller or an electro-magnetic roller.

In FIG. 4, a preferred embodiment of a magnetic roller 5 is shown schematically in more detail. The magnetic roller 5 comprises a plurality of magnets 8 arranged circumferentially within the magnetic 5 around the rotation axis of the magnetic roller 5. The magnets 8, which may be electromagnets and/or permanent magnets, may rotate with the magnetic roller 5 or their position may be fixed. Furthermore, the magnets 8 are arranged and configured such that an aligning magnetic field for at least partially aligning the elongate susceptor elements 3 extends at least partially circumferentially around the magnetic roller 5, at least in the portion of the magnetic roller 5 where the sheet material 4 and therefore the elongate susceptor elements 3 are passed over the magnetic roller 5, as shown in FIGS. 1A and 2A. The magnets 8 may be arranged having alternating outmost magnetic north poles N and south poles S along a circumferential direction of the magnetic roller 5 for generating the aligning magnetic field extending at least partially circumferentially around the magnetic roller 5. Thereby, the elongate susceptor elements 3 are at least partially aligned when passing over the magnetic roller 5.

In FIG. 5, a flow chart of a method according to the present invention is shown. The method of aligning elongate susceptor elements in an aerosol-forming substrate may be performed with a magnetic alignment apparatus 1 according to the present invention, as described above. In a first step 20, an aerosol-forming substrate is provided in the form of a sheet material 4, wherein the aerosol-forming substrate comprises elongate susceptor elements 3 deposited on a main surface of the sheet material 4 and/or dispersed throughout the aerosol-forming substrate provided as a sheet material 4. In a second step 21, the sheet material 4 comprising the elongate susceptor elements 3 is arranged close to a magnetic alignment device, which may comprise a magnetic roller 5. In a third step, 22, an aligning magnetic field is applied to the aerosol-forming substrate by means of the magnetic alignment device. The aligning magnetic field causes the elongate susceptor elements 3 to be attracted and aligned along the aligning magnetic field at least partially with respect to a reference axis R of the sheet material 4.

FIG. 6 shows a perspective view of a portion of a substrate element 110 or segment 110 forming part of a rod-shaped aerosol-generating article, including a detailed view (bottom right) of its inner structure, in particular the structure of an aerosol-forming substrate and the elongate susceptor elements 3. As can be seen from both, the perspective view and the detailed view, the aerosol-forming substrate is made from a sheet material 4 that has been gathered into the cylindrical shape of the substrate element 110 after alignment of the elongate susceptor elements 3. For example, the aerosol-forming substrate 4 may be made from a crimped tobacco sheet comprising a tobacco material, organic fibers, a binder, an aerosol. As can be further seen from the detailed view, at least some of the elongate susceptor elements 3 can be still observed even though the sheet material 4 is crimped and gathered. This may be, according to the present invention, the result of a manufacturing process including the deposition of the elongate susceptor elements 3 on a main surface of the sheet material 4 and a subsequent at least partial alignment of the elongate susceptor elements 3 and/or the dispersion of the elongate susceptor elements 3 throughout the aerosol-forming substrate provided as a sheet material 4 and a subsequent at least partial alignment of the elongate susceptor elements 3, either during a primary process, in which the sheet material 4 is produced, or during a secondary process, where the sheet material 4 is machined. The elongate susceptor elements 3 within the substrate element 110 are all aligned along their length dimension (predominant dimension) substantially in parallel with a pre-defined reference axis of the aerosol-generating article (corresponding to the reference axis R of the sheet material), here the length axis 101 of the article, which is chosen such that in use it coincides with the orientation M of the field lines of an alternating magnetic field used to inductively heat the elongate susceptor elements 3, for example when the aerosol-generating article is engaged with an aerosol-generating device providing the alternating magnetic field. As mentioned before, the heating efficiency is at maximum if the elongate susceptor elements 3 are all aligned in parallel to the orientation M of the alternating magnetic field.

FIG. 7 schematically shows manufacturing of the substrate element or segment 110. Downstream of the magnetic alignment apparatus 1, the sheet material 4 is conveyed through a funnel-shaped shaping device 120, thereby gathering the sheet material 4 into a rod 130. Downstream of the shaping device 120, a cutting device 140 cuts the rod 130 into substrate elements or segments 110. Each substrate elements or segment 110 comprises multiple susceptor elements 3.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-22. (canceled)

23. A method of aligning elongate susceptor elements in or on an aerosol-forming substrate for an inductively heatable aerosol-generating article, the method comprising the steps of:
providing an aerosol-forming substrate in the form of a sheet material, the aerosol-forming substrate comprising a plurality of elongate susceptor elements;
arranging the sheet material close to a magnetic alignment device; and
applying an aligning magnetic field to the aerosol-forming substrate by means of the magnetic alignment device, the aligning magnetic field causing the elongate susceptor elements to be attracted and aligned along the aligning magnetic field at least partially with respect to a reference axis of the sheet material.

24. The method according to claim 23, wherein the elongate susceptor elements are deposited on a main surface of the sheet material.

25. The method according to claim 23, wherein the elongate susceptor elements are dispersed throughout the aerosol-forming substrate provided as the sheet material.

26. The method according to claim 23, further comprising providing the aerosol-forming substrate comprising the plurality of elongate susceptor elements to or past the magnetic alignment device.

27. The method according to claim 23, further comprising conveying the aerosol-forming substrate comprising the plurality of elongate susceptor elements to the magnetic alignment device.

28. The method according to claim 23, further comprising supplying the elongate susceptor elements to the aerosol-forming substrate upstream of the magnetic alignment device.

29. The method according to claim 23, wherein the elongate susceptor elements are aligned at least partially such that an angle between a length dimension of the elongate susceptor elements and the reference axis is in a range between +30 degrees and −30 degrees.

30. The method according to claim 23, wherein the elongate susceptor elements are aligned substantially parallel to each other and to the reference axis.

31. The method according to claim 23, wherein during alignment of the elongate susceptor elements, the sheet material is moved relative to the magnetic alignment device in a conveying direction.

32. The method according to claim 23, wherein during alignment of the elongate susceptor elements, the sheet material is moved past the magnetic alignment device in a conveying direction.

33. The method according to claim 31, wherein the conveying direction is parallel to a plane defined by the sheet material or parallel to a plane tangent to the sheet material at a place of alignment.

34. The method according to claim 31, wherein the conveying direction is substantially parallel to the reference axis.

35. The method according to claim 23, wherein the magnetic alignment device is arranged vertically below the sheet material at a place of alignment.

36. The method according to claim 23, wherein the magnetic alignment device comprises at least one magnetic roller.

37. The method according to claim 36, wherein the magnetic field on an outside of the magnetic roller extends at least partially circumferentially around the magnetic roller.

38. The method according to claim 36, wherein the magnetic field on an outside of the magnetic roller extends at least partially in parallel to a rotation axis of the magnetic roller.

39. The method according to claim 23, wherein the aerosol-forming substrate is made from a substrate slurry cast into the form of the sheet material.

40. The method according to claim 39, wherein the elongate susceptor elements are deposited on a main surface of the sheet material or dispersed throughout the sheet material prior to drying the casted substrate slurry.

41. The method according to claim 23, wherein a ratio of a length dimension to a maximum transverse dimension of the elongate susceptor elements is greater than 4.

42. A method for manufacturing aerosol-generating segments for an inductively heatable aerosol-generating article, the method comprising:
the steps of the method according to claim 23;
gathering the sheet material into a rod downstream of the magnetic alignment device; and
cutting the rod into segments, wherein each segment comprises multiple susceptor elements.

43. An apparatus for aligning elongate susceptor elements in or on an aerosol-forming substrate for the method according to claim 23, the apparatus comprising:
a magnetic alignment device;
a substrate supply configured to provide an aerosol-forming substrate in a form of a sheet material to or past the magnetic alignment device, the aerosol-forming substrate comprising elongate susceptor elements; and
a susceptor supply configured to provide and to supply the elongate susceptor elements to the aerosol-forming substrate upstream of the magnetic alignment device,
wherein the magnetic alignment device is configured to apply an aligning magnetic field to the aerosol-forming substrate comprising the elongated susceptor elements, the aligning magnetic field causing the elongate susceptor elements to be attracted and aligned along the aligning magnetic field at least partially with respect to a reference axis of the sheet material.
